(19) United States
(12) Patent Application Publication
(10) Pub. No.: US 2014/0183985 A1
(43) Pub. Date: Jul. 3, 2014

(54) Rotating Electric Machine and Method for Manufacturing Stator Coil of Rotating Electric Machine

(71) Applicants: Yoshimi Kurahara, Tokyo (JP); Koji Obata, Tokyo (JP); Shuya Hagiwara, Tokyo (JP)

(72) Inventors: Yoshimi Kurahara, Tokyo (JP); Koji Obata, Tokyo (JP); Shuya Hagiwara, Tokyo (JP)

(73) Assignee: Hitachi Automotive Systems, Ltd., Ibaraki (JP)

(21) Appl. No.: 14/131,009

(22) PCT Filed: Jun. 11, 2012
(86) PCT No.: PCT/JP2012/064870

§ 371 Date: Jan. 6, 2014

(30) Foreign Application Priority Data
Jul. 14, 2011 (JP) 2011-155855

(51) Int. Cl. H02K 3/34; H02K 15/02

(52) U.S. Cl. CPC H02K 3/345; H02K 15/02
USPC 310/45; 29/596

(57) ABSTRACT

A large peeling force due to heat occurs at the boundary between the insulation coating over the coil end and the coil conductor when the stator coil emits heat and reaches a high temperature due to the high output of the rotating electric machine that causes the insulation coating to peel from the conductor consequently causing insulation defects. A sloped surface is formed on the insulation coating so that the thickness of the tip of the insulation coating on the coil end has a shape having a slope that becomes gradually thinner towards the welded coupling section made by welding the conductor.

### TECHNICAL FIELD

The present invention relates to a rotating electric machine such as electric motors and generators and relates in particular to a rotating electric machine that suppresses insulation defects in the stator coil ends.

### BACKGROUND ART

In recent years, rotating electric machines are being utilized in hybrid vehicles and electric vehicles by methods such as driving vehicle tires by way of electric motors or utilizing these electric motors as generators to charge a lithium cell by utilizing the drive inertia when an automobile decelerates.

There are also of course demands for a high output from these types of rotating electric machines; however, this high output causes new problems causing phenomena such as an increase in the vibration applied to the stator coil of the rotating electric machine or causes the stator coil to emit a large amount of heat.

In a specific example of a problem caused by heat emission, when a high temperature heat cycle is applied in particular to the stator coil of hybrid vehicles by repeated forward movement and stopping, a phenomenon occurs in which insulation defects tend to easily occur in the welded coupling section between the coil end of the stator coil and the other adjacent coil end.

In order to make an electrical coupling to the coil end of the other adjacent coil, the insulation coating (such as enamel sheath) on the coil end of the stator coil must be removed to expose the coil conductor section and each of the conductors coupled together by welding.

Methods proposed in the related art for removing the insulation coating on the coil ends include a method for removing the insulation coating by pressing a rotating brush up against the insulation coating such as disclosed in patent document 1, and a method for removing the insulation coating by immersing the insulation coating in organic solvent such as disclosed in patent document 2.

As described above, the insulation coating of the coil end is removed in order to couple the adjacent coil ends in the vicinity of the welded section on the coil ends of the stator coil.

During repetitive heat cycles in a state where a high temperature is reached from large heat emissions due to electrical current flow in the stator coil caused by the high output, or a state where the electrical current flow is cut off and the stator coil cools down from the high temperature; a large peeling force occurs due to heat at the boundary between the coil conductor and the insulation coating on the coil end and the insulation coating peels, consequently causing insulation defects to easily occur due to the insulation breaking down because of this peeling. This (peeling) phenomenon occurs each time the heat cycle repeats so a basic solution is required.

In the method disclosed in patent document 3, a varnish is applied to suppress deterioration of the insulation coating of the stator coil housed within a slot in the stator core caused by cutting oil or other factors. An incidental usage is that letting varnish soak into the coil end section of the stator coil creates an effect where the peeling phenomenon of the insulation coating on the boundary between the coil conductor and the insulation coating on the coil end can likely be suppressed to a certain extent due to the adhesive force of the varnish.

However, in this peeling suppression effect, a side effect that promotes the peeling phenomenon was found to occur when a high temperature heat cycle is applied to the stator coil. The reason is described in detail among the problems.

In either case, a high temperature heat cycle applied to the stator coil causes a large peeling force to occur and the insulation coating is peels due to heat at the boundary between the coil conductor and the insulation coating on the coil end so that this peeling consequently causes a breakdown in the insulation that makes insulation defects easily occur.

### CITATION LIST

### Patent Literature

Patent literature 1: Japanese Unexamined Patent Application Publication No. Heil0 (1998)-14182
Patent literature 2: Japanese Unexamined Patent Application Publication No. 2011-14510
Patent literature 3: Japanese Unexamined Utility Model Application Publication No. Hei5 (1993)-039178

### SUMMARY OF INVENTION

### Technical Problem

As described above, the method such as described in patent document 3 for covering the insulation coating with varnish was proposed as a method to generally protect the insulation coating of the coil from peeling and damage.

However, in addition to the peeling phenomenon due to repeated high temperature heat cycles, a side effect was found to likely occur, in which the epoxy type thermosetting resin utilized as the varnish, itself emits gas during high temperatures from 180° C. to 200° C. or more and after cooling later on, the volume of the varnish shrinks to promote a peeling phenomenon of the insulation coating due to the heat contraction of the varnish itself.

Therefore, not much can be expected from the peeling suppression effect on the insulation coating rendered by the varnish at high temperatures as implemented in the example of the related art for the phenomenon of large heat emissions from the stator coil accompanying a high output.

However, the use of the varnish is effective versus mechanical vibration and so cannot be excluded from the present invention. In other words, even varnish can be used if effective in preventing peeling.

Results from an analysis made by the present inventors, revealed that in the removal methods in patent document 1 and patent document 2, the tip section whose insulation coating was removed is in a state nearly perpendicular to the coil conductor surface.

When a heat cycle is then applied, the coil conductor and insulation coating each have their own unique expansion coefficient and so the expansion and contraction of the coil conductor and insulation coating are different from each other. However, when the removed section of the insulation coating is in a perpendicular state, the cross sectional area of the removed section of the insulation coating is approximately equal to the cross sectional area of a normal insulation coating, and the expansion force and the contraction force that accompanies the expansion and contraction becomes large in proportion to the cross sectional area.

The removed section of the insulation coating is therefore a perpendicular shape so that the cross sectional area at that section is a maximum and a large expansion force and contraction force are generated. A large gap therefore occurs relative to the coil conductor which consequently causes peeling. Moreover, the contraction force of the varnish applied here promotes the peeling phenomenon even further.

An object of the present invention is therefore to provide a rotating electric machine that prevents peeling of the insulation coating on the coil end due to the heat cycle.

### Solution to Problem

A feature of the present invention is that the tip of the insulation coating is formed in a sloped surface so that the thickness of the insulation coating on the coil end is a shape having a slope that gradually becomes thinner towards the welded coupling section of the conductor.

### Advantageous Effects of Invention

Forming the thickness of tip of the insulation coating so that the slope becomes thinner, prevents the peeling that occurs in the insulation coating due to heat contraction in the period from high temperature heat emission in the coil until cooling.

### BRIEF DESCRIPTION OF DRAWINGS

FIG. 1 is a cross sectional view of the rotating electric machine of the present invention;

FIG. 2 is a cross sectional view of the stator for the rotating electric machine shown in FIG. 1;

FIG. 3 is a perspective view of the cross section perpendicular to the axial direction of the rotor of the rotating electric machine shown in FIG. 1;

FIG. 4 is a perspective view of the stator having a winding structure for lap winding of the coil;

FIG. 5 is a perspective view of the coil end of the stator coil of the related art;

FIG. 6 is a cross sectional view taken along lines A-A of the coil end of the stator coil of the related art shown in FIG. 5;

FIG. 7 is a perspective view of the coil end of the stator coil of one embodiment of the present invention;

FIG. 8 is a cross sectional view taken along lines A-A of the coil end of the stator coil of one embodiment of the present invention shown in FIG. 7;

FIG. 9 is a descriptive drawing of the thermal stress on the boundary of the insulation coating tip;

FIG. 10 is a graph for describing the peel load characteristics relative to the taper angle of the cut surface of the insulation coating;

FIG. 11 is a descriptive drawing of the peel load fatigue limit strength of the insulation coating;

FIG. 12 is a perspective view of the coil end of the stator coil of another embodiment (second embodiment) of the present invention;

FIG. 13 is a cross sectional view taken along lines A-A of the coil end of the stator coil of another embodiment of the present invention shown in FIG. 12;

FIG. 14 is a cross sectional view of the coil end of the stator coil of still another embodiment (third embodiment) of the present invention;

FIG. 15 is a descriptive drawing of the manufacturing method of the coil end of the stator coil of the second embodiment of the present invention; and

FIG. 16 is a descriptive drawing of the manufacturing method of the coil end of the stator coil of the third embodiment of the present invention.

### DESCRIPTION OF EMBODIMENTS

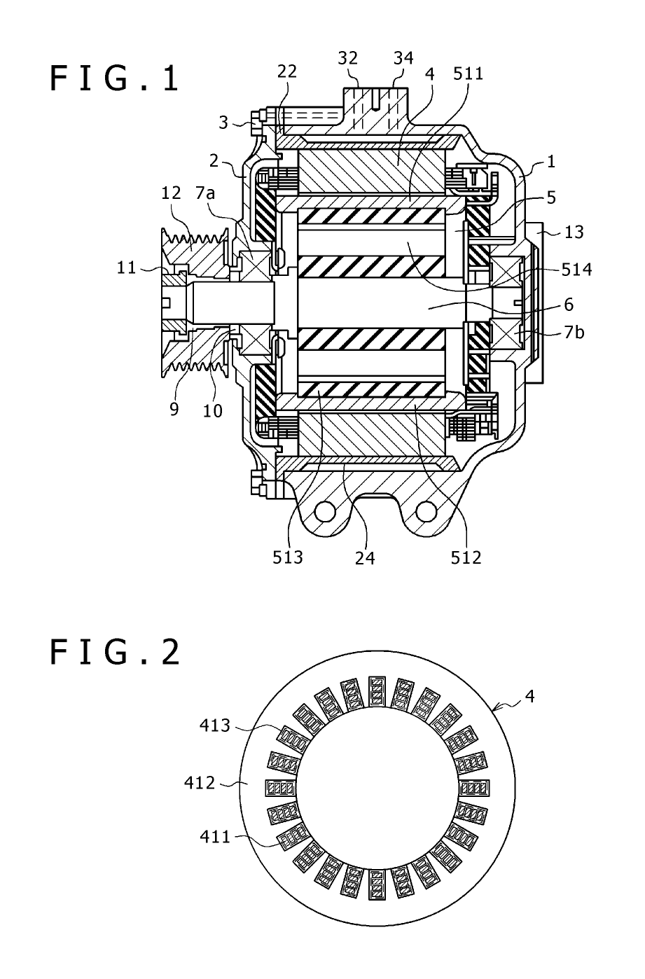

An embodiment of the present invention is hereafter described in detail while referring to the accompanying drawings. The rotating electric machine is first of all described while referring to FIG. 1 through FIG. 3.

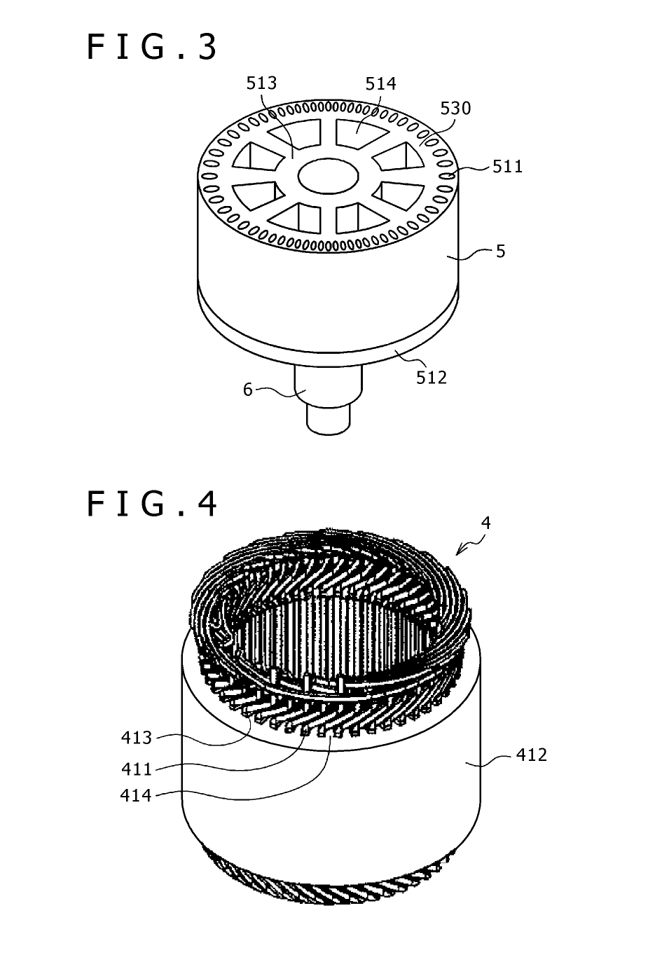

FIG. 1 is a cross sectional view of a basket type induction motor serving as the rotating electric machine of the present invention. FIG. 2 is a drawing showing a cross section of the stator shown in FIG. 1. FIG. 3 is a perspective view of the cross section perpendicular to the axial direction of the rotor.

In FIG. 1 through FIG. 3, the basket type induction motor includes a housing 1 in cylindrical shape with bottom surface whose one end in the axial direction is an opening, and a cover 2 for sealing the opening end of the housing 1. The housing 1 and the cover 2 are clamped by for example by six bolts 3.

A flow passage member 22 is formed in the inner side of a housing 1. The stator 4 is clamped to the inner side of this flow passage member 22 by shrink-fitting, etc. The flange at the left end shown in the drawing for the flow passage member 22 is enclosed and fastened between the housing 1 and the cover 2. A flow passage 24 is formed between the flow passage member 22 and the housing 1.

The coolant for cooling the rotating electric machine is drained from the drain outlet 34 of housing 1 after being filled into the flow passage 24 from the fill inlet 32 formed in the housing 1.

As shown in the cross sectional view in FIG. 2, the stator 4 is comprised of a stator core 412, on which a plurality of slots 411 are formed at equidistant intervals along the periphery, and a three-phase stator coil 413 inserted into each slot 411.

Twenty-four slots 411 are formed on the stator core 412 on which the stator coil 413 is inserted. The stator core 412 is formed into an annular shape containing inner circumferential slots formed by blanking or etching processing a single electromagnetic steel sheet with a thickness for example of 0.05 to 0.35 mm; a laminated steel plate is formed by stacking approximately several hundred of the formed electromagnetic steel sheets; and the plurality of slots 411 positioned radially at equidistant intervals are formed along the inner circumference.

Returning to FIG. 1, a rotor 5 is mounted on the inner circumferential side of the stator core 412 facing the stator core 412 by way of a small gap to allow rotation. The rotor 5 is clamped to the shaft 6 to rotate as one piece with the shaft 6; and this shaft 6 is supported for rotation by a pair of ball bearings 7a, 7b each respectively mounted in the housing 1 and the cover 2.

Among the bearings 7a, 7b, the bearing 7a on the cover 2 side is clamped to the cover 2 by a clamp plate not shown in the drawings, and the bearing 7b is clamped to a cavity section installed at the bottom of the housing 1.

A pulley 12 is mounted by way of the nut 11 on the left end of the shaft 6. A sleeve 9 and a spacer 10 are mounted between the pulley 12 and the bearing 7a of the shaft 6.

The outer circumference of the sleeve 9 and the inner circumference of the pulley 12 form a roughly cone shape and the pulley 12 and shaft 6 are firmly secured into one piece by the tightening force of the nut 11 and are capable of rotating as one integrated piece

When used as an electric motor, the rotor 5 is driven to rotate relative to the stator 4 and the rotational force of the shaft 6 is output externally by the pulley 12, when used as a generator, the rotational force from the pulley 12 is input to the shaft 6 and electricity is generated by the stator coil.

As shown in FIG. 3, in the rotor core 513 of the rotor 5 serving as the basket type rotor, a plurality of conductor bars 511 extending along the rotating axis direction are embedded circumferentially at equidistant intervals along the entire circumference.

The rotor core 513 is comprised of magnetic material, and shorting rings 512 are each respectively mounted on both axial ends of the rotor core 513 to electrically short each conductor bar 511.

The perspective view in FIG. 3 shows the cross sectional structure with a cross section of a surface perpendicular to the rotating axis, in order to clearly indicate the relation between the rotor core 513 and the conductor bars 511. The shorting ring 512 and the shaft 6 on the pulley 12 side are not shown in the figure.

The rotor core 513 is formed the same as the stator core 412 by blanking or etching processing an electromagnetic steel sheet with a thickness of 0.05 to 0.35 mm, and stacking approximately several hundreds of the formed electromagnetic steel sheets to forma laminated steel plate.

As shown in FIG. 3, fan-shaped cavities 514 are formed at equidistant intervals along the circumference to achieve a light weight on the inner side of the rotor core 513. The previously described conductor bars 511 are embedded on the outer circumferential side or in other words the stator side of the rotor core 513 and a magnetic circuit is formed on the rotor yoke 530 on the inner side of the conductor bar 511.

Each of the conductor bars 511 and the shorting rings 512 are formed from aluminum or aluminum alloy, and integrated into one piece with the rotor core 513 by die casting.

The shorting rings 512 mounted on both ends of the rotor core 513 are mounted so as to protrude from the rotor core 513.

Though not shown in FIG. 1, a detection rotor is mounted at the bottom side of the housing 1 in order to detect the rotation of the rotor 5. The rotation sensor 13 detects the rotation of the detection rotor teeth, and outputs an electrical signal in order to detect the position of the rotor 5 or the rotation speed of the rotor 5.

FIG. 4 shows the stator coil 413 extending longitudinally from within the stator core housed within the slot 411 of the stator core 412 to the outer side of the stator core.

One stator coil 413 is inserted into a pair of slots enclosing a specified number of slots.

A coil end (called coil end from hereon) 414 is formed on both end surfaces of the stator core 412 by the stator coil 413 protruding externally from each slot.

A straight section is formed by the stator coil 413 extending in a linear shape on the coil end 414 in the vicinity of outlet section of each slot. An insulation film is wound between the stator core 412 and the stator coil 413.

Vibration occurs in the stator coil 413 housed in the stator core 412, the stator core 412, and the insulation film due to rotational vibration of the rotor 5 separated by a gap and mounted to allow rotation.

In order to prevent this vibration of the stator core 412 and the stator coil 413 and to prevent electrical breakdown of the insulation due to damage caused during insertion of the stator coil 413 into the stator core 412, a varnish comprised of epoxy synthetic resin is soaked into the stator core 412.

A varnish comprised of epoxy synthetic resin covers the insulation coating surface of the coil to protect the insulation coating between each of the conductor wiring for the coil end 414 and the stator coil 413.

In the rotating electric machine as described above, insulation defects between the insulation coating and the conductor of the coil end 414 and method of the present invention for solving the problem are described.

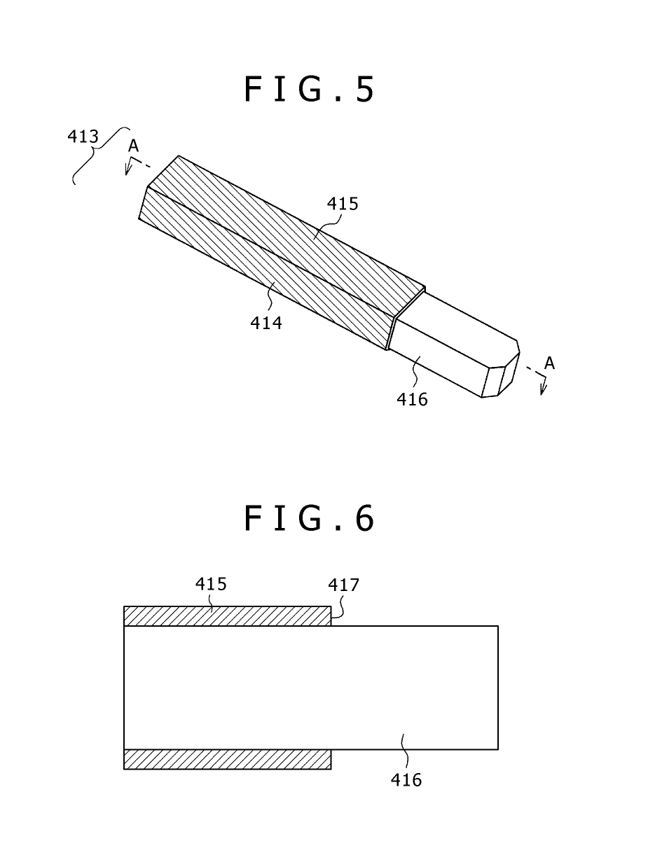

FIG. 5 shows an external view of the coil coupling section of the coil end 414 of the related art. FIG. 6 shows a cross sectional view taken along lines A-A in FIG. 5.

The stator coil 413 is overall comprised of a conductor 416 and an insulation coating 415 of enamel material of polyamide-imide or polyester-imide covering this conductor 416.

The insulation coating 415 in the vicinity of the coil end 414 of the stator coil 413 of the related art is then removed to expose the conductor 416. This exposed conductor 416 is coupled by welding to conductor 416 of the adjacent coil end inserted in another slot of the stator core 414.

However, in the above described methods for removing the insulation coating 415 by utilizing a rotating brush or organic solvent as shown in patent document 1 and patent document 2, the slope on the tip of the stripped surface 417 of the insulation coating 415 was found to become a perpendicular shape of approximately 90 degrees relative to the surface of the conductor 416 as in the cross section shown in FIG. 6.

When a heat cycle is then applied, the conductor 416 and the insulation coating 415 each have their own unique expansion coefficients and so will have respectively different expansion and contraction.

When the stripped surface 417 of insulation coating 415 is a perpendicular shape, the cross sectional area of the stripped surface 417 of insulation coating 415 is approximately the same as the cross sectional area of a normal insulation coating 415, and the expansion force and contraction force that accompanies expansion and contraction becomes large in proportion to the cross sectional area.

The stripped surface 417 of the insulation coating is a perpendicular shape relative to the conductor 416 so that the cross sectional area at the stripped surface 417 becomes a maximum, and a large expansion force and contraction force are generated in axial direction or in perpendicular direction, or in both directions of the conductor on this section.

A large gap therefore occurs between the conductor 416 and the stripped surface 417 of the insulation coating so that the peeling phenomenon occurs.

Moreover, at the tip section of the stripped surface 417 of the insulation coating 415, a phenomenon was found to occur that further peels the insulation coating 415 from the conductor 416 due to generation of a force that promotes peeling at the boundary of the insulation coating 415 and the conductor 416, caused by the heat contraction force generated in the varnish that covers the insulation coating 415 when the temperature drops from a high environmental temperature.

Therefore, as described above, when the stator coil emits heat due to the high output from the rotating electric machine causing a high temperature, a large peeling force occurs due to heat at the boundary of the coil conductor 416 and the insulation coating 415 of the coil end 414, and the insulation coating consequently peels from the conductor 416 so that insulation defects tend to easily occur.

Whereupon, the present invention proposes a technology that is capable of preventing the phenomenon of peeling of the insulation coating 415 from the conductor 416 due to the heat cycle.

### First Embodiment

In the first embodiment of the present invention, a sloped surface 418 is formed on the insulation coating so that the thickness of the tip of the insulation coating 415 on the coil end 414 becomes a shape having a slope that is gradually thinner towards the welded coupling section where the conductor 416 is welded.

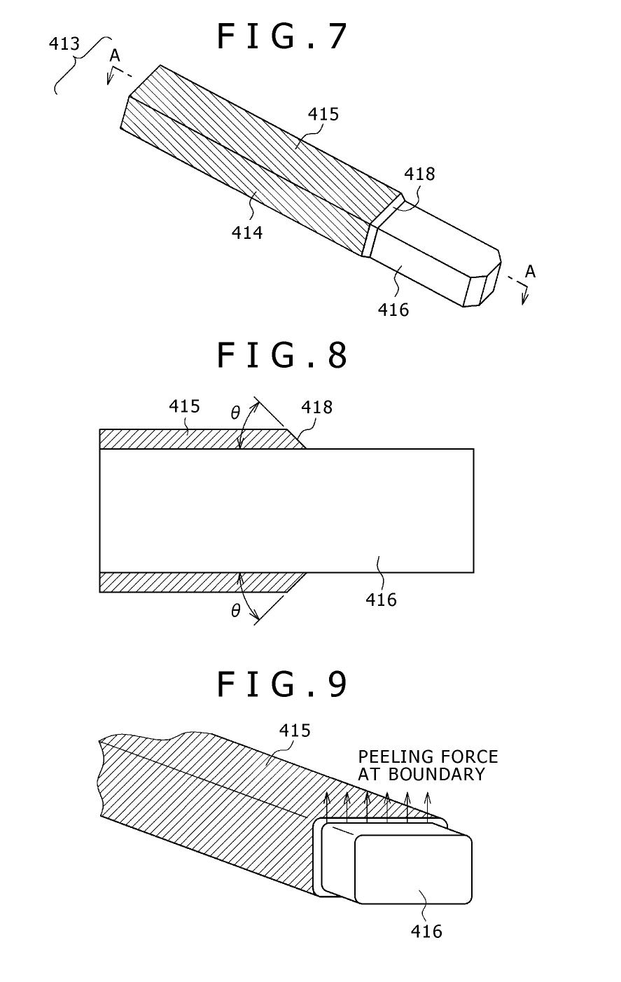

The structure of the coil end 414 of the first embodiment is hereafter described in detail. FIG. 7 shows an external view of the coil coupling section of the coil end 414 of the first embodiment. FIG. 8 shows a cross sectional view taken along lines A-A in FIG. 7.

The stator coil 413 is a rectangular lead (a so-called rectangular wire), and the coil end 414 is a conductor on which an insulation coating 415 is formed and the conductor 416 whose the insulation coating 415 is removed, that forms the welded coupling section.

Here, the conductor 416 is formed as a conductor whose cross section is rectangular with no change in shape including the section where the insulation coating 415 is formed, and the insulation coating 415 is formed uniformly over this conductor.

The tip of the insulation coating 415 is formed with a sloped surface 418 having a slope angle A relative to the surface of the conductor 416 so that the thickness of just the insulation coating 415 gradually becomes thinner towards the tip side of the coil end 414. For example, when the conductor 416 is a rectangular copper wire, a sloped surface 418 having a slope angle θ is formed so that the thickness of the tips at the four points on the insulation coating 415 contacting each surface (four surfaces) of the conductor 416 gradually becomes thinner.

Here, the sloped surface 418 is formed in a linear shape but a curve shape may be utilized and a small number of irregularities may be present under actual circumstances. What is required is that the tip thickness of the insulation coating 415 of the coil end 414 is a shape whose slope becomes gradually thinner towards the welded coupling section where the conductor 416 is welded, and need only be capable of suppressing the peel load of the insulation coating 415 described later on to a specified value.

A sloped surface 418 is in this way formed having a slope angle θ so that the thickness of the stripped surface of the insulation coating 415 becomes gradually thinner. The expansion force and the contraction force due to the heat cycle generated in this section is proportional to the cross sectional area and so becomes gradually smaller as this cross sectional area decreases. The expansion force and the contraction force at the end point of the sloped surface 418 therefore become considerably smaller. Therefore, the peeling between the conductor 461 and the sloped surface 418 of the insulation coating 415 can be prevented.

The sloped surface 418 formed as described above is capable of preventing peeling even if a contraction force from the varnish is applied, because of the basically strong coupling of the sloped surface 418 of insulation coating 415.

Here, the sloped surface 418 at the tip of the insulation coating 415 and the slope angle θ of the surface of the conductor 416 must preferably be set to a value so that the peeling force generated at the boundary of the insulation coating 415 and conductor 416 when the stator coil 413 is transitioning from a high temperature to a cooling temperature (or the reverse) does not exceed the peel load on the insulation coating 415.

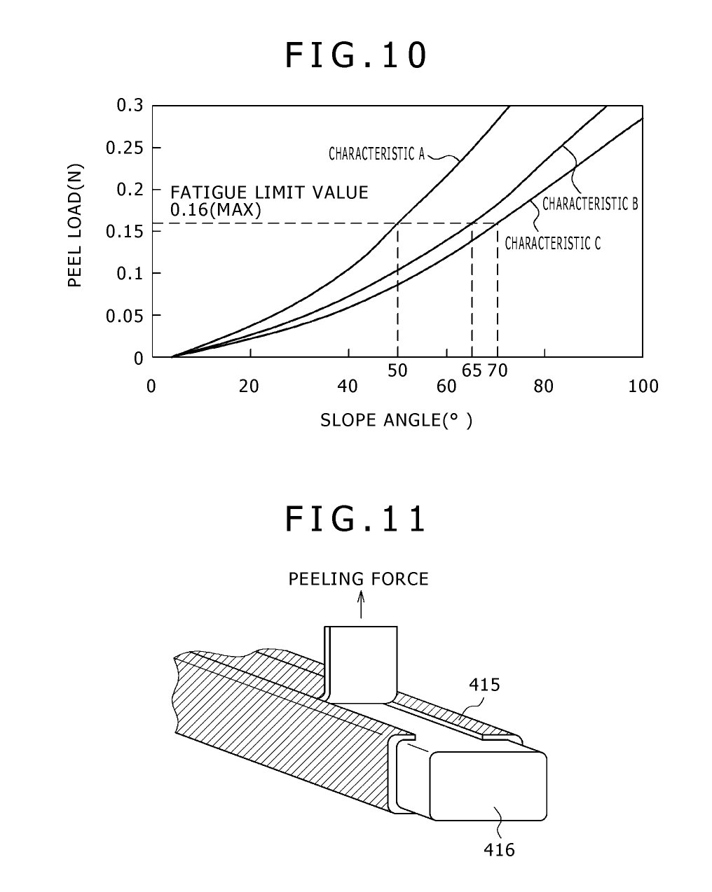

FIG. 9 is a descriptive drawing showing the thermal stress at the boundary of the tip of the insulation coating 415 and the conductor 416. FIG. 10 is a descriptive drawing showing the peel load characteristics relative to the slope angle of the tip (stripped surface) of the insulation coating 415. FIG. 11 is a descriptive drawing showing the peeling fatigue limit strength of the insulation coating 415.

As shown in FIG. 9, the peeling force at the boundary of the insulation coating 415 and conductor 416 at the time of returning to an ambient temperature of 20° C. after being heated to 180° C. in the heat cycle tends to reach a maximum at the tip section of the insulation coating 415.

The vertical axis in FIG. 10 shows the value of the peel load, and the horizontal axis shows the slope angle of the sloped surface 418 of the insulation coating 415. Here, three types of generally utilized insulation coatings are prepared for usage as the insulation coating 415.

One type is a coil (characteristic A) covered with a polyamide-imide layer on the conductor periphery; one type is a coil (characteristic B) covered with a plural layers of polyimide and polyamide-imide on the conductor periphery; and one type is a coil (characteristic C) covered with a polyimide layer on the conductor periphery.

As shown in FIG. 10, in the coil covered with a polyamide-imide layer, the coil covered with plural layers of polyamide-imide and polyimide, and the coil covered with a polyimide layer; the peeling force at the boundary of the insulation coating 415 and the conductor 416 tends to decrease as the slope angle of the tip surface of the insulation coating 415 becomes smaller. Peeling is therefore found to occur when this peeling force at the boundary of the insulation coating 415 and the conductor 416 exceeds the fatigue limit value that peels the insulation coating 415.

FIG. 11 shows an example when measuring the actual peel load on the insulation coating 415 and the coils for measurement are the coil covered with a polyamide-imide layer, the coil covered with plural layers of polyimide and polyamide-imide, and the coil covered with a polyimide layer.

A peeling width of 1.5 mm was set in a state where it has returned to an ambient temperature of 20° C. after being heated to 180° C. in the heat cycle, and peeling then performed, and the load at this time measured with a force gauge. Consequently, the fatigue limit value that peels the insulation coating 415 was approximately a maximum of 0.16 N.

Returning to FIG. 10, the fatigue limit value after heating to 180° C. in the heat cycle is therefore a maximum of 0.16 N revealing that a slope angle satisfying a maximum of 0.16 N as a fatigue limit value may be set to a slope angle of 50 degrees or less for a coil covered with polyamide-imide layer; and may be set to a slope angle of 65 degrees or less for a coil covered with plural layers of polyimide and polyamide-imide; and may be set to a slope angle of 70 degrees or less for a coil covered with polyimide layer.

### Second Embodiment

In the second embodiment of the present invention, the sloped surface 419 is formed on the surface of the insulation coating 415 and the conductor 416 so as to be a shape for which the thickness of the tip of the insulation coating 415 of coil end 414 forms a slope that becomes gradually thinner towards the welded coupling section by welding.

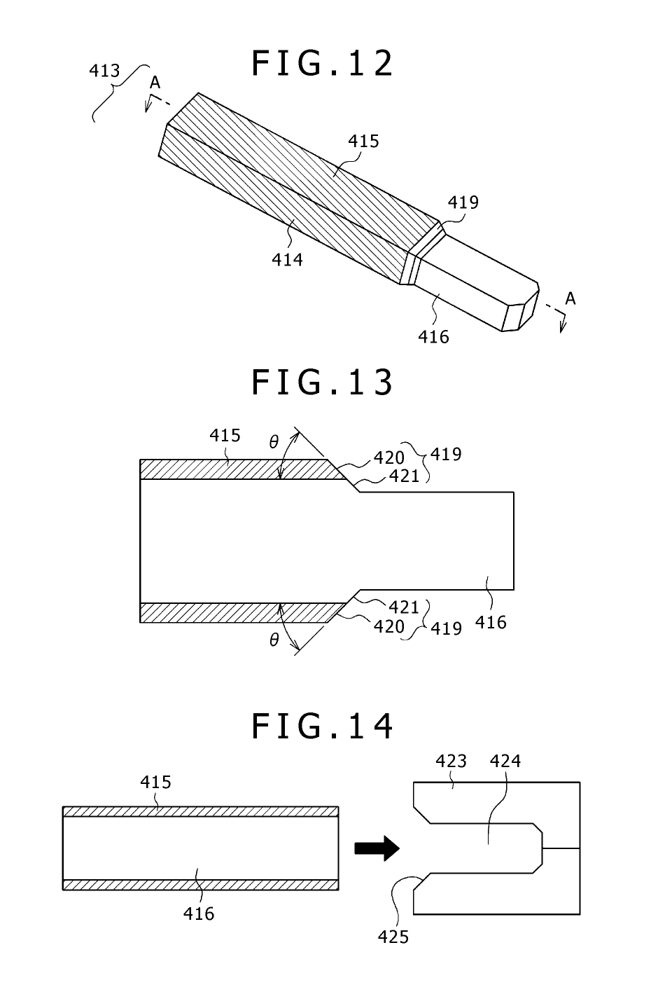

The structure of the coil end 414 of the second embodiment is hereafter described in detail. FIG. 12 shows an external view of the coil coupling section of the coil end 414 in the second embodiment. FIG. 13 shows a cross sectional view taken along lines A-A in FIG. 12.

In contrast to the first embodiment, where the tip surface of just the insulation coating 415 forms a slope, in the second embodiment an insulation coating side sloped surface 420 is formed on the tip surface of the insulation coating 415, and a conductor side sloped surface 421 is formed on the inner side from the conductor main surface of the conductor 416 followed by this insulation coating side sloped surface 420, to together form a sloped surface 419.

In this embodiment also, the four surfaces of the rectangular copper wire are structured so that a slope is formed as the surface of the conductor 416 and the tip of the insulation coating 415 on the four locations, on the surface of the conductor 416 and the insulation

Also, as shown in FIG. 10, the fatigue limit value after heating to 180° C. is therefore a maximum of 0.16 N revealing that a slope angle satisfying a maximum of 0.16 N as a fatigue limit value may be set to a slope angle of 50 degrees or less for a coil covered with polyamide-imide layer; and may be set to a slope angle of 65 degrees or less for a coil covered with plural layers of polyimide and polyamide-imide; and may be set to a slope angle of 70 degrees or less for a coil covered with polyimide layer.

Further, compared to the first embodiment, the second embodiment can be expected to render the effect of a method that easily forms the continuous sloped surface 419 on the surfaces of the insulation coating 415 and the conductor 416.

Namely in contrast to the first embodiment that required a precision technology in a forming process that removed just the insulation coating 415 since the sloped surface 418 was formed only on the insulation coating 415; in the second embodiment, a continuous sloped surface 419 is formed over the surfaces of the insulation coating 415 and the conductor 416 so that a boundary can be formed between the insulation coating 415 and the conductor 416 without a clear division, and the second embodiment can be expected to render the effect of not requiring a precision technology in a forming process that was needed in the first embodiment.

The effect can also be anticipated that the insulation film mounted in the slot beforehand can be mounted in the stator without damage since the coil tip is a fine shape compared to the first embodiment.

In this embodiment also, the sloped surface 419 need not be a strictly linear shape, and more specifically may have a shape in which the thickness of the tip of the insulation coating 415 of the coil end 414 becomes gradually thinner towards the welded coupling section where the conductor 416 is welded, and is satisfactory provided that the peel load of the insulation coating 415 is suppressed to within a specified value.

The method for forming the coil end including the sloped surface 419 of the second embodiment is described next.

In FIG. 14, the reference number 423 denotes a metallic press mold comprised of a split mold. The interior of this metallic press mold 423 includes a space 424 where the conductor 416 of the stator coil is inserted, and a sloped angle section 425 is formed at the inner surface of the tip side.

This space 424 forms the exposed conductor 416 from the insulation coating 415 of the stator coil, and the sloped angle section 425 forms the sloped surface 419 shown in FIG. 13.

When mounting the stator coil covered with insulation coating at the bottom in the metallic press mold 426, the metallic press mold 423 stamps the conductor 416 and insulation coating 415 at a specified downward pressing force into the specified shape (here, the shape shown in FIG. 13). In the case of a rectangular copper wire, only two surfaces can be formed so the coil is completed by next rotating this coil 90 degrees and stamping again in the metallic press mold 423.

### Third Embodiment

In the third embodiment of the present invention, a sloped surface 422 is formed on the surface of the insulation coating 415 and conductor 416 so as to be a shape having a slope in which the thickness of the tip of the insulation coating 415 of the coil end 414 becomes gradually thinner towards the welded coupling section formed by welding the same as in the second embodiment.

Here, the point differing from the second embodiment is that an arc shaped sloped surface is formed over the conductor 416.

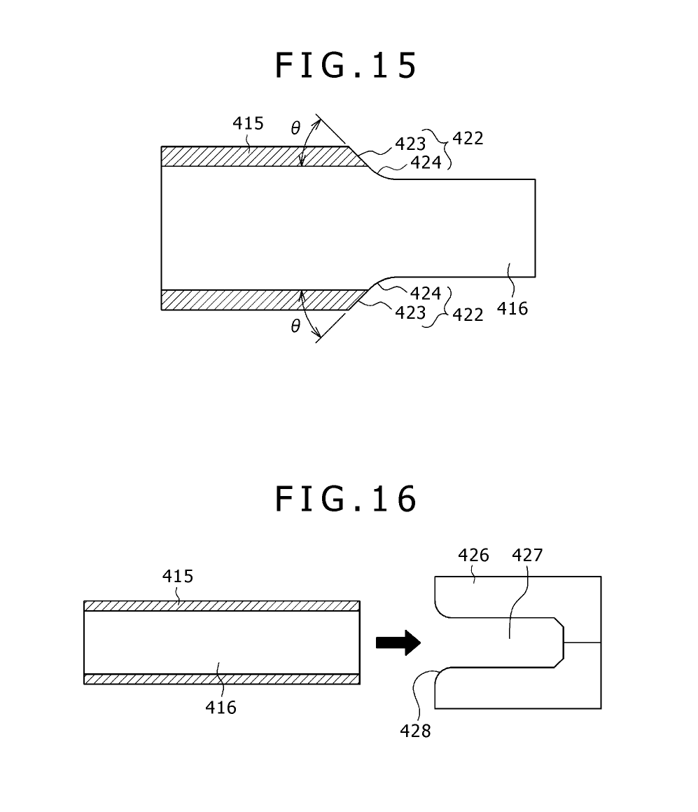

FIG. 15 is a drawing showing a cross section of the welded coupling section of the stator coil 414 of the third embodiment. In this embodiment, the tip surface of the insulation coating 415 has an insulation coating side sloped surface 423 formed in linear shape on the tip surface of the insulation coating 415 the same as in the second embodiment, and the surface of the conductor 416 is a smooth arc shaped conductor-side sloped surface 424 as the sloped surface. The four surfaces of the rectangular copper wire are of course structured so that a linear shaped sloped surface is formed on the tip of the insulation coating 415 and an arc shaped sloped surface is formed on the surface of the conductor 416 at four locations, over the surface of the conductor 416 and insulation coating 415 contacting the surface of the conductor 416.

In this embodiment also, the fatigue limit value after heating to 180° C. in the heat cycle as described in FIG. 10 is a maximum of 0.16 N so that a slope angle satisfying a maximum of 0.16 N as a fatigue limit value may be set to a slope angle of 50 degrees or less in a general-purpose AIW of polyamide-imide layer as the main material; and maybe set to a slope angle of 65 degrees or less in insulation coating of plural layers of polyimide and polyamide-imide.

The present embodiment can also be expected to render the effect of a method that easily forms having the continuous sloped surface 422 on the surfaces of the insulation coating 415 and the conductor 416.

The same effect as in the second embodiment can also be anticipated in this embodiment or namely that the insulation coating mounted in the slot beforehand can be mounted in the stator without damage since the coil tip is a fine shape compared to the first embodiment.

The method for forming the coil end including the sloped surface 422 in the third embodiment is described next.

In FIG. 16, the reference number 426 denotes a metallic press mold comprised of a split mold. The interior of this metallic press mold 426 includes a space 427 where the conductor 416 of the stator coil is inserted, and a sloped angle section 428 having a continuous sloped surface and an arc shaped surface, is formed at the inner surface of that tip side.

This space 427 forms the exposed conductor 416 from the insulation coating 415 of the coil the same as shown in FIG. 14, and the sloped angle section 428 forms the sloped surface 422 as shown in FIG. 15.

When actually mounting the stator coil covered with insulation coating at the bottom in the metallic press mold 426, the metallic press mold 426 stamps the conductor 416 and the insulation coating 415 at a specified downward pressing force into the specified shape (here, the shape shown in FIG. 15). In the case of a rectangular copper wire, only two surfaces can be formed, so the coil is completed by next rotating this coil 90 degrees and stamping again in the metallic press mold 423.

The method for forming the first embodiment was omitted but a sloped surface can be formed on the insulation coating 415 in the same way as in the first embodiment if a metal mold such as for stamping a sloped surface on insulation coating 415 is fabricated.

### LIST OF REFERENCE SIGNS

1 . . . rotating electric machine, 4 . . . stator, 5 . . . rotor, 411 . . . slot,
412 . . . stator core, 413 . . . stator coil, 414 . . . coil end,
415 . . . insulation coating, conductor . . . 416, 418 . . . sloped surface,
419 . . . sloped surface, 420 . . . insulation coating side sloped surface,
421 . . . linear shaped conductor side sloped surface, 422 . . . sloped surface,
423 . . . insulation coating side sloped surface,
424 . . . arc shaped sloped surface, 423 . . . metal mold,
424 . . . space, 425 . . . sloped angle section.

1. A rotating electric machine at least comprising:
an annular shaped stator core that includes a rotor storage space;
a plurality of slots formed at equidistant intervals along the inner circumference of the stator core;
a plurality of coils that include respective coil ends inserted in the slots and coupled by a welded coupling section to adjacent coils, and are covered with insulation coating on other than the coil ends; and
a rotor housed in the rotor storage space, and
wherein a sloped surface is formed on the tip of the insulation coating toward the coil end so that the thickness of the tip of the insulation coating has a slope that becomes gradually thinner towards the welded coupling section of the coil end.

2. The rotating electric machine according to claim 1,
wherein the sloped surface is formed only at the tip of the insulation coating.

3. The rotating electric machine according to claim 1,
wherein the sloped surface is formed towards the inner side from the tip of the insulation coating and the surface of the conductor of the coil end.

4. The rotating electric machine according to claim 3,
wherein the sloped surface from the surface of the conductor of the coil end towards the inner side is formed in a linear shape.

5. The rotating electric machine according to claim 3,
wherein the sloped surface from the surface of the conductor of the coil end towards the inner side is formed in an arc shape.

6. The rotating electric machine according to claim 1,
wherein when the insulation coating is formed from plural layers of polyamide-imide and polyimide, the slope angle of the sloped surface formed at the tip of the insulation coating is 65 degrees or less.

7. The rotating electric machine according to claim 1,
wherein when the insulation coating is formed from polyamide-imide, the slope angle of the sloped surface formed at the tip of the insulation coating is 50 degrees or less.

8. The rotating electric machine according to claim 1,
wherein when the insulation coating is formed from polyimide, the slope angle of the sloped surface formed at the tip of the insulation coating is 70 degrees or less.

9. The rotating electric machine according to claim 1,
wherein the coil is rectangular wire, the insulation coating is formed on four sides of the rectangular wire, and the tip of the insulation coating is formed with a sloped surface having a slope that becomes gradually thinner towards the welded coupling section of the coil end.

10. A stator coil manufacturing method for a rotating electric machine,
wherein a rotating electric machine includes:
an annular shaped stator core that includes a rotor storage space;
a plurality of slots formed at equidistant intervals along the inner circumference of the stator core;
a plurality of coils that include respective coil ends inserted in the slots and coupled by a welded coupling section to adjacent coils, and that are covered with insulation coating on other than the coil ends; and
a rotor housed in the rotor storage space,
wherein an insulation coating formed on the coil end is formed as a sloped surface on the tip of the insulation coating by a metallic mold stamping process that stamps it into a shape so as to have a slope that becomes gradually thinner towards the welded coupling section of the coil end.

11. A stator coil manufacturing method for a rotating electric machine,
wherein a rotating electric machine includes:
an annular shaped stator core that includes a rotor storage space;
a plurality of slots formed at equidistant intervals along the inner circumference of the stator core;
a plurality of coils that include respective coil ends inserted in the slots and coupled by a welded coupling section to adjacent coils, and that are covered with insulation coating on other than the coil ends; and
a rotor housed in the rotor storage space,
wherein an insulation coating formed on the coil end and the inner side from the surface of the coil conductor are formed as a sloped surface on the tip of the insulating coating and the inner side of the conductor by a metallic mold stamping process that stamps them into a shape so as to have a slope that becomes gradually thinner towards the welded coupling section of the coil end.

12. A stator coil manufacturing method for a rotating electric machine according to claim 11,
wherein the sloped surface is formed in a linear shape from the insulation coating to the conductor by a metallic mold stamping process, or the insulation coating is formed in a linear shape, and the conductor is formed in an arc shape by a metallic mold stamping process.
